(19) United States
(12) Patent Application Publication
(10) Pub. No.: US 2019/0383621 A1
(43) Pub. Date: Dec. 19, 2019

(54) JOURNEY SEGMENT PERFORMANCE ANALYSIS

(71) Applicant: Ford Motor Company, Dearborn, MI (US)

(72) Inventors: Jeanne Isaacs, Los Altos, CA (US); Sudipto Aich, Palo Alto, CA (US); Justin Danielson, Dearborn, MI (US); Will Farrelly, San Francisco, CA (US)

(21) Appl. No.: 16/009,066

(22) Filed: Jun. 14, 2018

(51) Int. Cl. G01C 21/34; G06Q 30/02; G06Q 10/02; G06Q 10/04; G06Q 50/30

(52) U.S. Cl. CPC G01C 21/3423; G06Q 30/0282; G06Q 50/30; G06Q 10/047; G06Q 10/025

(57) ABSTRACT

A provider, such as a transportation management service, can manage transport for a number of riders between various locations. Individual routes can include at least two segments using the same or different modes of transportation. A customer can select a transportation option for the journey that causes reservations to be made for the various segments. Upon completion of a journey, a customer can be prompted to provide feedback. This can include feedback for the individual segments, in addition to the overall multi-segment journey. The feedback can be allocated across aspects or components of the various segments, and aggregated with feedback from other users in order to generate performance data for the various segments, routes, aspects, and components used to provide the various transportation or mobility options. This information can be utilized in making routing determinations for future transportation requests, and can be exposed to the various transportation providers.

### BACKGROUND

People are increasingly turning to a variety of different transportation and mobility offerings, including ridesharing and e-biking in addition to conventional transit offerings such as trains and public buses. Many of these different modes of transportation are provided by different entities, which can include both public and private entities. For at least some of these types of entities, it is difficult to collect feedback from customers, particularly where the identities of the customers may not be known to the entities. Further, for riders who utilize multiple modes of transportation it can be difficult to determine how much different aspects impact the overall impressions of the riders as to their transportation experience.

### BRIEF DESCRIPTION OF THE DRAWINGS

Various embodiments in accordance with the present disclosure will be described with reference to the drawings, in which:

FIGS. 1A and 1B illustrate an example ride request environment in which aspects of various embodiments can be implemented.

FIGS. 2A and 2B illustrate example feedback that can be provided by various riders or customers in accordance with various embodiments.

FIG. 3 illustrates an example set of feedback information that can be determined for various aspects of a set of transportation options that can be determined in accordance with various embodiments.

FIGS. 4A and 4B illustrate example preferences that customers can provide to take advantage of determinations made within the scope of the various embodiments in determining and selecting routing options.

FIG. 5 illustrates an example approach for matching ride requests to vehicle capacity that can be utilized in accordance with various embodiments.

FIGS. 6A and 6B illustrate example origination and destination locations, and routes for serving those locations, that can be determined for a service area over a period of time in accordance with various embodiments.

FIG. 7 illustrates an example system that can be utilized to implement aspect of the various embodiments.

FIG. 8 illustrates an example process for collecting and analyzing customer feedback of a set of transportation options that can be utilized in accordance with various embodiments.

FIG. 9 illustrates an example process for reserving new transport for one or more future journeys using determined transportation ratings that can be utilized in accordance with various embodiments.

FIG. 10 illustrates an example process for determining routing options for a plurality of ride or transport requests that can be utilized in accordance with various embodiments.

FIG. 11 illustrates an example computing device that can be utilized to submit trip requests and receive route options in accordance with various embodiments.

FIG. 12 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to the providing of transportation between specified locations. In particular, various embodiments provide approaches for determining and selecting from possible routing solutions, of one or more modes of transportation, to serve a set of transportation requests. The requests can relate to the transportation of people, animals, packages, or other objects or passengers, from an origination location to a destination location. The requests may also include at least one time component, such as a requested time of departure or arrival. A provider, such as a transportation service, can utilize a routing determination process, for example, to balance various metrics when selecting between proposed routing solutions to serve a set of customer trip requests. One or more optimization processes can be applied, which can vary the component values or weightings of the routing process in order to attempt to improve the options generated and/or selected for each proposed routing solution. A solution can be selected for implementation based at least in part upon the resulting quality scores of the proposed routing solutions.

In at least some embodiments, the routes selected between a point of origin and a destination can include at least two legs or segments, which can be provided by the same or different modes of transportation. A customer can submit a request for transportation between an origin and a destination at, or near, a specified time, and can receive information for traveling options along one or more routes between those locations. In at least some embodiments, a customer can select then select one or more options for the journey. The transportation for the selected option(s) can then be booked, such that sufficient capacity is reserved for the rider. A determination can then be made that the customer, or an associated rider, is undertaking the journey using the reserved capacity. Upon completion of the journey, or at least one or more segments of the journey, the customer or rider can be prompted to provide feedback. This can include feedback for the individual segments of the journey, in addition to the overall multi-segment journey. The feedback can be allocated across aspects or components of the various segments, in addition to the overall journey, and then aggregated with feedback from other users in order to generate overall rating or performance data for the various segments, routes, aspects, and components used to provide the various transportation or mobility options. This information can then be utilized in making routing determinations for future transportation requests. Further, at least some of this information can be exposed to the providers of the various vehicles, routes, or components, which might otherwise have difficulty obtaining such information, particularly when normalized against similar performance data for other providers or modes of transportation. This can be particularly valuable for entities such as government transport agencies that do not collect customer data or other such information.

Various other such functions can be used as well within the scope of the various embodiments as would be apparent to one of ordinary skill in the art in light of the teachings and suggestions contained herein.

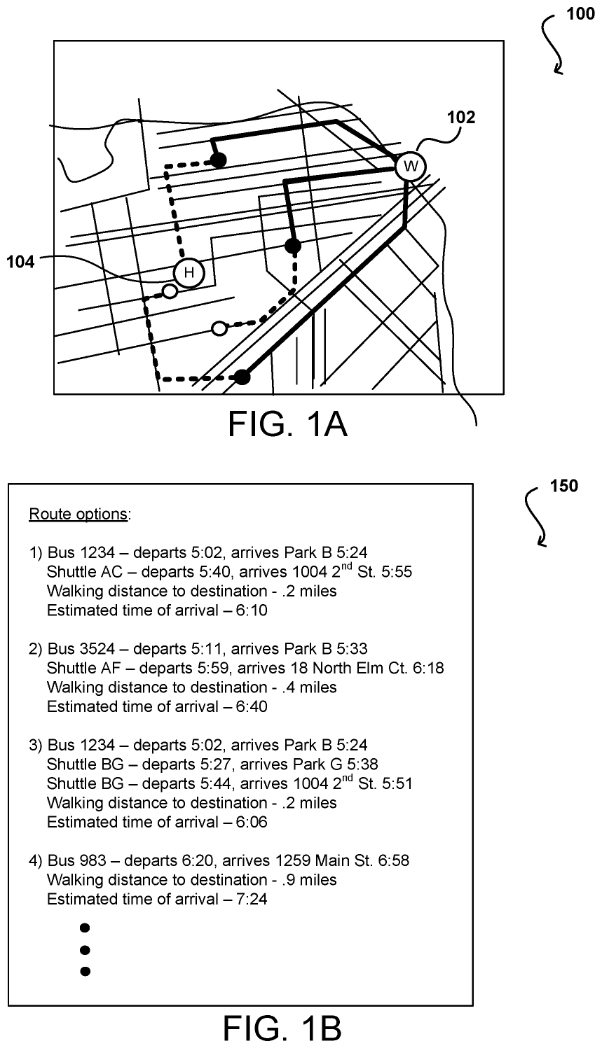

FIG. 1A illustrates an example location 100 in which aspects of the various embodiments can be implemented. In this example, a user can request transportation from an origin 102 to a destination location 104 using, for example, an application executing on a client computing device. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using one or more vehicles (or other modes of transportation) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. The rides provided to an individual rider from the point of departure to the point of arrival may also involve one or more vehicles, which may be of the same or different types, for the same or different modes of transportation. For example, in FIG. 1A a customer of a transportation service might want to use the service to obtain transport from a specified origin 102 or point of departure, such as the customer's place of employment, to a specified destination 104 or point of arrival, such as the user's home. Various other types of locations or ways of specifying locations can be used as well within the scope of the various embodiments. There may be modes of transportation offered that use fixed routes (such as trains or public buses), semi-fixed routes (such as shuttle buses), flexible routes (such as rideshares in passenger vehicles), or complete flexibility (such as e-bikes or scooters), among other such options. While more flexible options, such as ride shares, may provide for the shortest travel times in some situations, they may also come at a higher cost than fixed route options, such as subways or public buses. Further, flexible route options such as rideshares may be subject to traffic congestion or other issues that may introduce additional uncertainty into arrival times, etc.

For at least some of these reasons, customers or riders may choose to take fixed route transportation for at least some of their journey. For example, a customer might take a public bus (i.e., a trunk line offering with fixed stops) out of downtown due to the relatively low cost and frequent availability of the buses. These buses can go to one or more stops from which the customer can obtain a connecting transport if needed, or desired, to complete a remainder of the journey. In many instances, a customer might want flexibility in the timing of the bus or initial mode of transport, such as to be able to catch the next available bus along a given route. A customer might also want to be able to select from multiple available routes to obtain additional options. As illustrated in FIG. 1A, there may be a number of bus routes (illustrated using the solid lines) that go from a destination, such as a bus stop near the customer's place of employment, to one or more destinations along substantially fixed routes. The customer may be willing to take any of these routes from the point of origin 102, particularly at rush hour or in inclement weather, etc.

In some embodiments discussed herein, a customer can view potential options for routes that involve multiple legs or segments, which may utilize one or more types of transportation. The customer can then select the option that is most desirable or of interest to them, or at least most closely satisfies the customer's current selection criteria, as may include timing and price, among other such options. An example presentation 150 of a set of options is illustrated in FIG. 1B. In this example, the customer is able to view a number of different options that satisfy, or otherwise at least partially match, one or more search criteria submitted by the customer for a future transportation need. As illustrated, the options can include different times of departure near the customer's requested time, that all leave from a specified location. The options include different options for the initial leg, here including different buses that travel at different times and/or to different locations. From those locations, there are different options presented to continue on towards the destination. These include not only different connection options, such as different shuttles, but also include options for walking or biking certain distances, etc. A user can select from among these options, and a transportation service or other entity system providing the options can cause corresponding reservations to be made for the selected options, such as for capacity on specific vehicles or routes as made through the corresponding transportation providers, which may include public entities or other third parties in at least some embodiments. It should be understood, however, that in at least some embodiments a user can have the option to book separate segment transport separately, or to utilize a conventional approach to anonymously boarding a bus or train, among other such options.

As mentioned, the providers of various transportation and mobility options will often want to obtain customer feedback in order to better determine the quality of their offerings, as well as ways in which those offerings could be improved. For some entities that provide specific types of transportation options, such as ride sharing obtained through a mobile app, the obtaining of at least some amount of customer feedback may be relatively straightforward. For other entities, such as public transportation entities where the identities or other information about its customers may not be known, the ability to obtain such information may be minimal. Further still, when customers utilize multiple modes of transportation from multiple entities to get between locations, it can be difficult to obtain feedback information for the individual modes, as well as the impact of the customer impression on the overall satisfaction for the journey.

In various embodiments discussed herein, a customer can obtain transportation through an application or other interface or mechanism provided by a transportation service provider, or other such entity. The transportation service provider might be the same as one of the entities offering one of the modes of transportation, or might be a separate entity, such as one that contracts with the various entities. The service provider can accept the trip requests from various customers, determine the appropriate route options from amongst the various transportation options available, then reserve capacity for the relevant rider(s) with the entities offering the relevant modes of transportation for the selected route option(s). This might include, for example, booking a ticket on a train offered by a government transportation authority as well as a seat on a rideshare vehicle offered by a private company, etc. An advantage of such an approach is that the customer only has to deal with one entity to manage the various transportation options.

This single point of contact also enables an entity such as a transportation service provider to obtain feedback and other customer information that is relevant not only to the overall transportation service option, but also to aspects of the individual modes or segments of transportation that may be provided by one or more other entities. The information from various customers can be aggregated and analyzed to determine not only the overall ratings or impression of the various aspects, but also the impact of those aspects on the overall customer experience. Further, the ratings information can be used during the route optimization and/or selection process to provide options that are more likely to be acceptable to the relevant customer based upon the experience of other users and/or preferences of the relevant customer, among other such options.

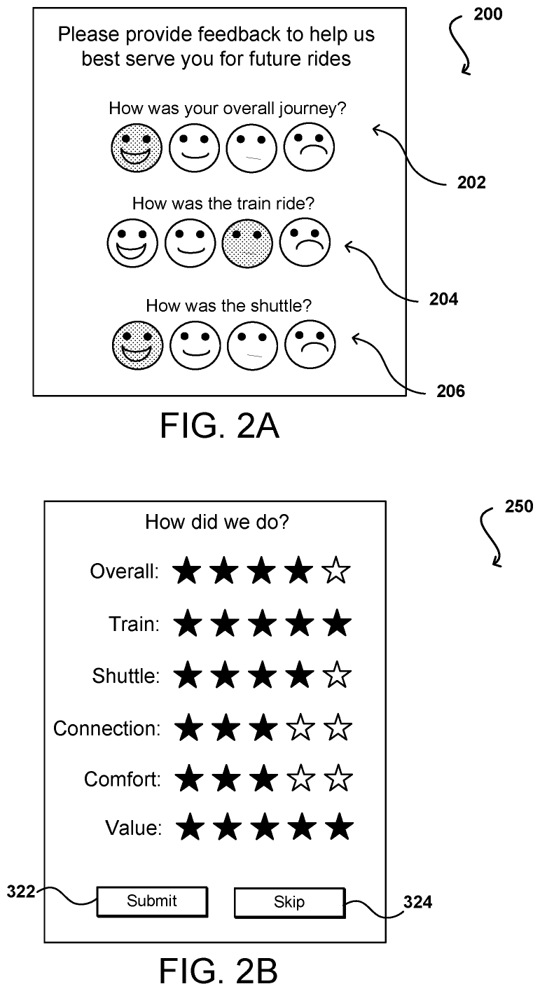

In some embodiments, an application associated with a service provider might provide various options that a customer or rider can use to provide feedback, as a rider might in certain cases be a different person than the customer, or the rider may not be human at all but the customer can provide feedback about the transportation provided, among other such options. In some embodiments an interface can be displayed after completion of a journey, or segment of a multi-segment journey, in an application executing on a mobile device or other appropriate interface. FIG. 2A illustrates one example interface 200 that can be displayed through a mobile app associated with the transportation service provider. This particular interface can be relatively simple, which can be practical when utilized on mobile devices such as smart phones that may have limited display space. Further, the simplicity can make it more likely that customers or riders will provide feedback relating to the completed journey, or portion thereof.

In this example, the interface asks a set of three basic questions relevant to a two-segment journey. It should be understood that there can be a different number of questions for a different number of segments or modes of transportation, or different questions relevant for different providers or entities, among other such options. In this example the rider completed a two-segment journey where one segment involved transport via train and the other segment involved transport by shuttle. The three questions can then relate to an overall rating 202 or impression of the transportation provided, as well as a first individual rating 204 for only the train ride portion and a second individual rating 206 for only the shuttle portion. The approach used to provide the rating can include any appropriate feedback, review, or ranking mechanism known or used for such purposes, such as the face-based feedback approach of FIG. 2A or the star rating approach of FIG. 2B, among other such options. A customer or rider having completed a journey, or portion thereof, can provide feedback in FIG. 2A for the overall journey 202 by selecting a face image or graphical element that represents the person's subjective impression of the quality or satisfaction for the overall journey, including the individual segments and any connections, waits, or other such aspects. In this example the person has selected an option that represents the highest level of satisfaction, corresponding to a face with a big smile. The other options in this example correspond to somewhat happy, reasonable, or unhappy, or similar feelings corresponding with progressively lower levels of satisfaction. The transportation service provider can use this information to determine customer satisfaction with their service in general, and can apply that rating over the various components or aspects that make up the journey.

It will often be the case, however, that the overall rating for a journey will not be the same, or consistent with, ratings that a person might have given other aspects or individual components of the journey. For example, in FIG. 2A the customer feedback for the train portion 204 was merely reasonable, while the feedback for the shuttle portion 206 was very happy or satisfied. Using the overall rating alone would have given the impression that the person was very happy with both segments of the journey, which is not the case. The ability to gain information for the individual segments helps the transportation service provider to better understand customer satisfaction with individual segment options, which helps the service provider to select or recommend better or more favorable options to the same customer, or other customers, for future rides. Such information is also helpful for the providers of the vehicles or services for the individual segments, as these providers may not have otherwise been able to obtain such feedback. For example, the train portion may be provided by a government agency that does not obtain customer identity and thus does not have a way to track feedback for those customers. The ability to gather this information for various users and segments and provide that information can thus be very valuable to the individual providers. Further, because this information is being gathered by a single entity, the providers of the individual segment options or modes of transportation can obtain information enabling them to compare the satisfaction of customer of their service with those of competing services or other modes of transportation, which can help to better understand relative satisfaction and levels of satisfaction for different modes of transportation.

Further, the ability to obtain ratings for the individual segments helps a provider to understand the impact or weighting that the individual segments or modes of transportation have on the overall rating. For example, in FIG. 2A the customer rated the train ride as merely satisfactory, but was very satisfied with the overall journey. This might be due to any of a number of different factors, such as the train ride being a short portion of the overall journey or the customer not caring as much about the train portion, where options or alternatives might be minimal. It might also be the case that the customer has lower expectations of that particular mode of transportation, such that they do not factor their experience on the train as much into their overall satisfaction determination as they do with a shuttle, where they may have various options of different qualities and pricing. Other factors can come into play as well, such as more recent segments being fresher in the customer's mind, or being more likely to be impacted by strong or poor experiences with connections or other aspects experienced during the course of the journey. When customers take similar transportation options in both directions, and the customers can be tracked through their account with a single service provider, the impact of the ordering or other aspects can be averaged out over time, such that the customer's overall impression of the importance of a mode of transportation or segment can be determined, then factored into future transportation options, suggestions, or selections.

In some embodiments there can be more questions or the feedback can be more granular, directed to different or additional aspects of a particular journey. While there can be benefits to a provider of receiving the additional information, the use of additional questions or feedback options should be balanced with the willingness of customers to provide feedback, as customers may be very willing to take the time to provide a single feedback rating, but often unwilling to provide feedback for ten to twenty different aspects of a single journey. In the example interface 250 of FIG. 2B the customer is provided with six feedback options, which might be the most provided at one time in some embodiments. In other embodiments there might be fewer options provided, such as at most three to four, but at least one of those options can be rotated over time. For example, an interface might always ask for an overall rating, and may ask for feedback on the individual segments. A final option might rotate or change over time, asking a user to provide feedback on aspects such as specific connections, stops, comfort, safety, value, and the like. In this way, the provider can gain at least some amount of feedback for these additional aspects without overburdening, or turning off, the user. In many instances it will be desirable to avoid anything, at least to the extent possible or practical, that would negatively impact the overall customer experience. A customer can also have the option of providing feedback for less than the full set of options and then selecting an option 322 to submit only those ratings, or an option 324 to skip providing feedback for any of the options, etc.

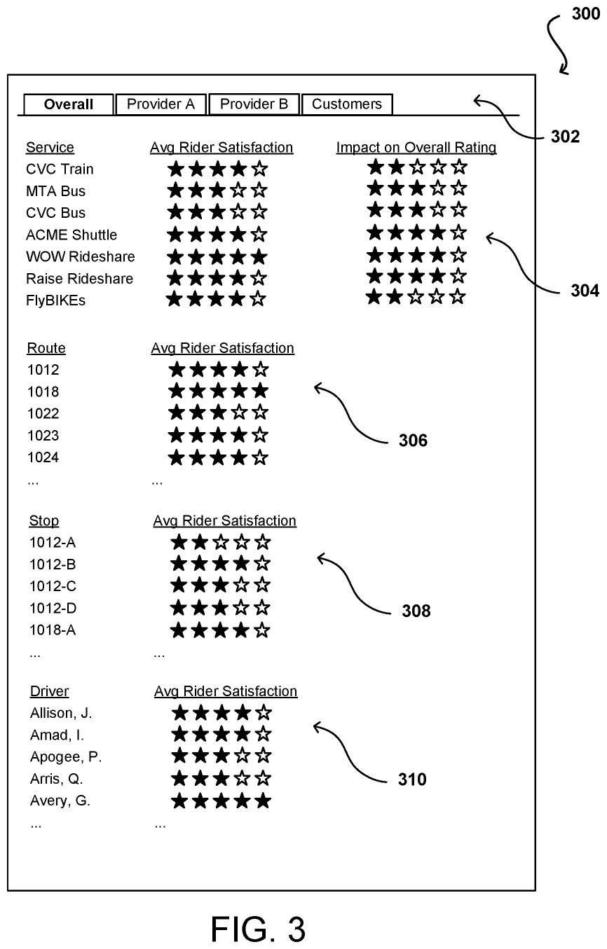

Once information is obtained for the individual segments, this information can be further broken down by aspects or parameters associated with those individual segments. For example, a given segment will have a mode of transportation, a particular vehicle, a driver or operator (except in the case of autonomous or customer-operated vehicles), a route, and other associated aspects. The segment reviews can then also be aggregated based on common drivers, routes, vehicles, and the like, which can help to provide ratings on individual aspects that might otherwise not have been available. FIG. 3 illustrates an example interface 300 that can be generated in accordance with various embodiments. In this example, the ratings have been aggregated across various aspects of the transportation service. The interface provides options 302 that enable viewing or accessing information for the overall service, specific providers, specific customers or types of customers, or other categories of data. For a given category of data, the overall (i.e., averaged or weighted) rating can be displayed, which can be used to compare customer ratings for the various aspects in a normalized fashion. Such information would not otherwise have been available, particularly where different transportation options are provided by different entities or through different systems or services.

For example, a first set 304 of example ratings illustrates ratings for different transportation offerings, including different modes of transportation as well as different providers of a single mode of transportation. This enables transportation providers to determine their relative performance with respect to competitors offering the same mode(s) of transportation, as well as being able to determine customer satisfaction relative to other modes of transportation. For example, the bus providers in this example might be discouraged by the fact that their ratings are lower than for other modes of transportation, but may be at least somewhat encouraged by the fact that their performance is similar to other bus providers. Thus, the bus providers might determine that customers enjoy the bus less as a mode of transportation, and that the low ratings are not necessarily based upon the performance of the individual bus provider. In this example the impact of that mode or provider of transportation on the overall rating can be determined. This may not be of as much value to the individual providers, but can be valuable to the transportation service provider when ranking or recommending options to users. The transportation service provider can utilize the individual provider ratings, as well as the impact of those ratings on overall customer satisfaction, when selecting options to provide for customers submitting future requests. It should be noted that impact can be aggregated for individual customers as well, such that the selections can be more personalized to a specific user in at least some embodiments.

As illustrated, ratings for other aspects can be viewed or compared as well, including ratings for specific routes 306, stops 308, or individual drivers 310, among other such options. This information can be utilized for various reasons of value to the business, but at least within the scope of various embodiments can be used when determining, ranking, or optimizing route options for various transport requests. Such information can also be provided to the various individual entities or providers, which might not otherwise have access to such information, at least at this level of granularity and not normalized with respect to performance of other entities or providers, at least to the extent that such information is exposed to competing services or providers. In some embodiments a provider might be provided with feedback relative to their service, which then can be compared against generalized or anonymous data for other transportation providers analyzed under the service. It should be noted that in some embodiments a transportation service provider might collect feedback information for routes not operated by, or otherwise associated with, the transportation service provider, such as where the transportation service provider offers a third party feedback collection and analysis service.

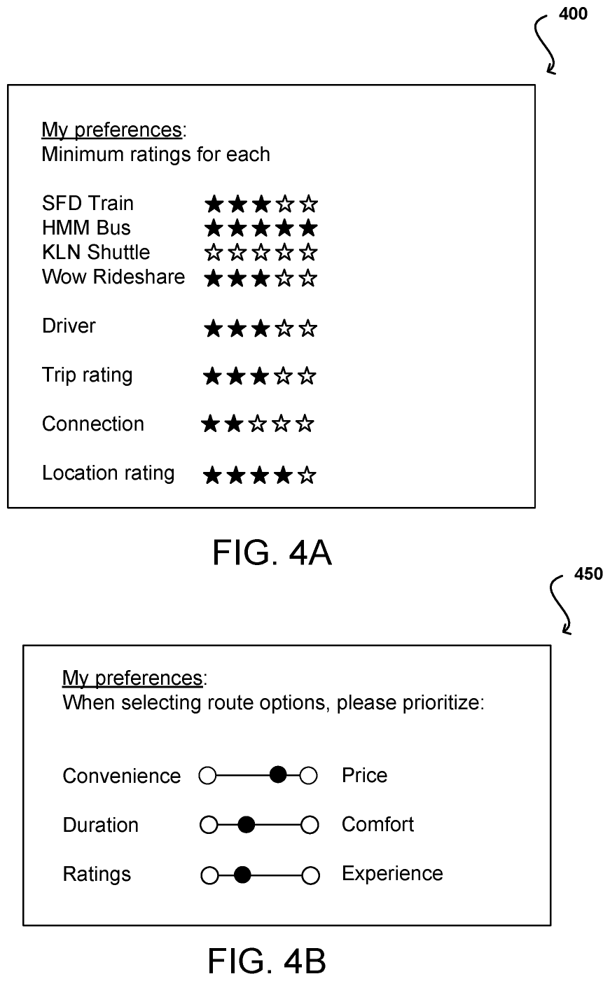

As mentioned, any or all of this information can be utilized with a route determination and/or optimization function, or other such transportation management approach, as discussed and suggested elsewhere herein. In some embodiments customers may also have the ability to provide preference information that can be used to weight these and other factors in the route determination process. As mentioned elsewhere herein, customer preference data can also be learned implicitly by analyzing customer data (current and historical) using machine learning or another such approach. FIGS. 4A and 4B illustrate example approaches to collecting customer preference data that can be utilized in accordance with various embodiments. In the example interface 400 of FIG. 4A, a customer can input the minimum acceptable ratings for various aspects of the transportation service that will be acceptable to the user. These can then be used to determine or select from among various routing options for subsequent routing requests for that customer. In this example, a customer has provided minimum ratings for various modes of transportation. The customer may not like taking the bus, and thus may accept a bus segment only if the particular bus segment is very highly rated. On the other hand, the customer might always prefer the shuttle and thus might accept any segment that is available on a shuttle regardless of the rating. Preferences can be provided for the other modes of transportation as well. In some embodiments a default rating, such as three stars, might be provided for the various options, such as where a transportation service provider strives to only provide options having at least that level of performance. As illustrated, the customer can provide minimum acceptable ratings for other transportation aspects as well, such as for the driver or operator, overall trip, individual connections, or locations, among other such options.

FIG. 4B illustrates another example preference input interface that can be utilized in accordance with various embodiments. In this example, a customer can provide preference information for various pairings of transportation aspects. A customer can specify which of each pairings they prefer, and how strongly. Various other mechanisms can be used to obtain such information as well as would be apparent to one of ordinary skill in the art in light of the teachings and suggestions herein. In this example interface 450, a user can specify whether they prefer drivers and route based on user ratings or that have more experience or a better track record. Similarly, a customer might specify whether the customer prefers shorter or more comfortable journeys. At least some of the ratings information for the various aspects described herein can be used with these preference weightings when suggesting or optimizing various transportation options for future transportation requests.

As mentioned, such approaches allow for the collection and analysis of feedback data for generating ratings or performance data for various aspects or individual components of a set of journeys, including multi-segment journeys where the transportation for the segments can be performed by different providers or entities. The information can be aggregated across all riders and analyzed to extract or pinpoint the impact of the rating. In at least some embodiments the questions or feedback opportunities can be provided through a mobile application or other such interface that is available near, at, or just after completion of at least a segment of a current journey. In some embodiments a question might be asked after each segment or connection, in addition to after completion of the overall journey. Further, while one to five star ratings or similar approaches can be used, various other feedback mechanisms (e.g., thumbs up or down, numerical ratings, etc.) can be used as well within the scope of the various embodiments. In some embodiments the feedback may not be as explicit but can be collected in other ways, such as to provide an option for a user to provide a compliment to a driver or for a specific segment, and the text of the compliment can be analyzed to determine the intent or level of satisfaction from that text.

As with single ride preferences, there can be customer preferences determined for selecting transportation for journeys requiring multiple segments. For example, a customer might prefer the shortest overall time duration regardless of the number of connections or modes of operation used. Others might prefer comfort, shortest connection times, or minimum number of connections, among others. For some customer, the preferences may vary by direction. For example, a customer might want to take only enclosed vehicles on the way to work, but may be more willing to walk or bike on the way home. Certain customers may also have preferred or required stop locations, or can specify locations or modes of transportation that are not to be used. A customer can also specify specific segments, vehicles, routes, or other aspects that are preferred, required, or not to be selected, etc. Various other options can be specified, such as maximum use of highway versus neighborhood driving, minimum or maximum pricing, minimum or maximum quality of service, etc. Any or all of these and other factors or preferences can be used with a routing selection and/or optimization function or process as discussed and suggested herein. Further, as mentioned at least some of these preferences can be learned for a customer over time.

In some embodiments an entire journey can be automatically booked or suggested to a customer. For example, a customer might leave from work at the same time on most weekdays. Accordingly, the service could send a notification to the customer as discussed above, but this notification instead could ask the user to confirm booking on the initial segment of the journey. This might be the same transportation option that the customer usually takes, or can be one of the options that are appropriate for the time and location. The user can confirm, select an option, decline, or specify new criteria for this particular time, such as an updated departure time or location. Various other options can be used as well within the scope of the various embodiments. In such a situation, the customer might have to confirm the selections for the subsequent segments of the journey, or the initial confirmation may enable the system to automatically book transport for each segment at a time appropriate based on any factors, or combinations thereof, discussed herein.

In some embodiments, the automatic booking may require the customer to take different actions as well. For example, the customer might be on a train or bus that makes multiple stops. In some embodiments, the transportation options for the next segment may depart from different stops or stations, such that the customer may need to be notified of the appropriate stop at which to catch the connection. If this is to be different from the typical or standard stop for that customer, or is anything other than the last stop, then the customer may need to confirm that the customer has received the instruction and will get off at the appropriate stop. In some embodiments the next segment can be automatically confirmed in response to the customer getting off at that stop, which can be detected by sensor, location, or other approaches such as those discussed and suggested herein. Similarly, the customer can be notified if a better option would require the customer to stay on the current mode of transportation longer and instead get off at a later stop, etc. In some embodiments an application can also have an option where the user can indicate that the user would like to get off at a different stop, get to the destination sooner, or otherwise modify one or more segments. The service can then take this information and determine the best booking option based on the current location and desire of the customer.

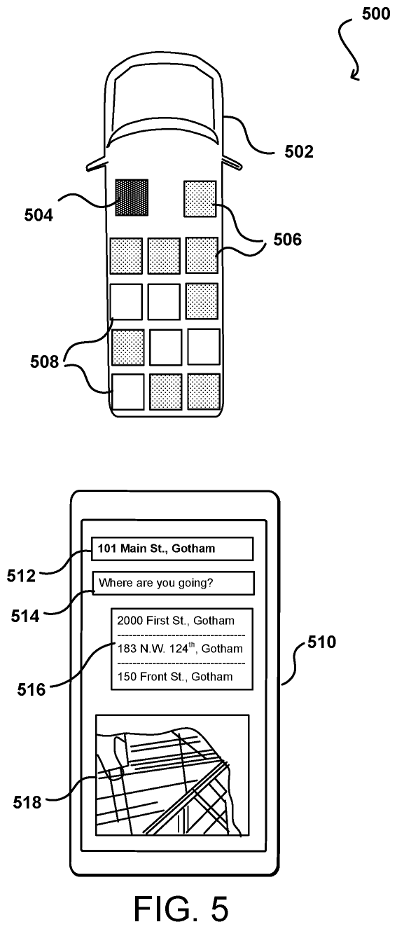

Various systems and services can be used to implement aspects of the invention as discussed and suggested herein. A transport service that provides vehicles that can concurrently be used by more than one rider is often referred to as a “rideshare” service, although as discussed vehicles such as bikes and scooters can be utilized as well which may only serve one customer at a time in at least some embodiments. In one example, a rideshare service can offer routes using at least one type of vehicle 502 that includes space 504 for a driver and seats or other capacity for up to a maximum number of riders, as illustrated in the example configuration 500 of FIG. 5. It should be understood that various types of vehicles can be used with different numbers or configurations of capacity, and that autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 506 (or other rider locations) may be occupied by riders, while another number of seats 508 may be unoccupied. In some embodiments objects such as packages or deliveries may also occupy available space for a ride as well, which can include areas for seating or cargo, or convertible space, among other such options. In order to improve the economics of the rides offered, it can be desirable in at least some embodiments to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

A user can request transportation from an origination to a destination location using, for example, an application executing on a client computing device 510. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using a vehicle 502 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. In this example, a rideshare service offers routes using at least one type of vehicle that includes space 504 for a driver and seats or other capacity for up to a maximum number of riders. It should be understood that various types of vehicles can be used with different numbers or configurations of capacity, and that autonomous vehicles without dedicated drivers can be utilized as well within the scope of the various embodiments. In order to improve or maximize the economics of the rides offered, it can be desirable in at least some embodiments to have the occupancy or utilization as close to full as possible during the entire length of the trip. Such a situation results in very few unsold seats, or little unsold capacity, which improves operational efficiency. One way to achieve high occupancy might be to offer only fixed routes where all passengers board at a fixed origination location and off-board at a fixed destination location, with no passengers onboarding or off-boarding at intermediate locations. As mentioned, such an approach may be beneficial for at least one segment of a given customer journey.

In the present example, a given user can enter an origination location 512 and a destination location 514, either manually or from a set of suggested locations 516, among other such options, such as by selecting from a map 518 or other interface element. In other embodiments, a source such as a machine learning algorithm (or trained neural network, etc.) or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or dedicated rideshare vehicles that do not require the additional effort. Accordingly, it can be desirable in at least some embodiments to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. It therefore can be desirable in at least some embodiments to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

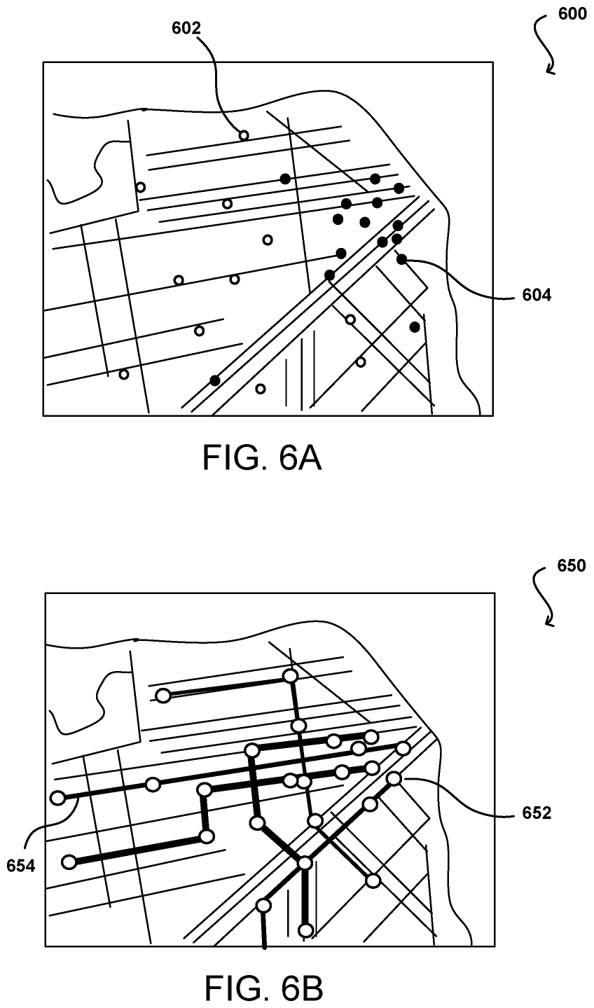

FIGS. 6A and 6B illustrate one example approach that can be utilized to provide such service in accordance with various embodiments. In the example mapping 600 of FIG. 6A, a set of origination points 602 and destination points 604 indicate locations, over a determined period of time, between which one or more users would like to travel. As illustrated, there are clusters of locations where users may want to be delivered, or objects are to be delivered, as may correspond to town centers, urban locations, or other regions where a number of different businesses or other destinations are located. The origin locations, however, may be less clustered, such as may relate to suburbs or rural areas where rider homes may be located. The clustering can also vary throughout the day, such as where people travel from their homes to their places of employment in the mornings, and generally travel in the reverse directions in the evening. There may be little clustering between these periods, or the clustering may be primarily to locations within an urban area. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation. Similarly, requiring a large number of passengers to meet at the same origination location may be inconvenient for at least some of those passengers, who may then choose alternate travel options.

It thus can be desirable, in at least some embodiments, to provide routes and transportation options that balance, or at least take into consideration, these and other such factors. As an example, the mapping 650 of FIG. 6B illustrates a selection of routes 652 that can be provided over a period of time in order to satisfy various rider requests. The routes may not include or correspond to each precise origination and destination location, but can come within an acceptable distance of those locations in most instances. Each route can also be served by one or more vehicles or modes of transportation, each servicing a portion or segment of a given route. There may be situations where origination or destination locations are not served, or served at particular times, where route options may not be available, although in some embodiments a dedicated, limited capacity vehicle may be offered at a determined price, among other such options. Further, while the routes may not enable every vehicle to have full occupancy, the number of passengers per vehicle can be sufficient to provide at least adequate profitability or efficiency to the ridesharing service. The routes 652 provided by such a service may change over time, or even at different times of day, but can have at least a subset of segments that are sufficiently set such that riders can have at least some level of certainty over their commute or travel. While this may not offer the flexibility of other travel options, it can provide certainty of travel at a potentially lower cost point, which can be desirable to many potential users of the service. As mentioned, however, such a service can also provide added flexibility with other ride options, which may come with a higher price to the potential rider.

In order to determine the routes to provide, as well as the vehicles (or types of vehicles) to use to provide those routes, various factors can be considered as discussed and suggested herein. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. In some embodiments an artificial intelligence-based approach, as may include machine learning or a trained neural network, for example, can be used to further optimize the function based upon various trends and relationships determined from the data as discussed elsewhere herein.

Approaches in accordance with various embodiments can utilize at least one objective function to determine route options for a set of vehicles, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. In some embodiments the routing option with the highest route score will be selected, while in other embodiments there can be approaches to maximize or minimize the resulting score, or generate a ranking, among various other scoring, ranking, or selection criteria. Routing options with the lowest score may be selected as well in some embodiments, such as where the optimization function may be optimized based on a measure of cost, which may be desirable to be as low as possible, versus a factor such as a measure of benefit, which may be desirable to be as high as possible, among other such options. In other embodiments the option selected may not have the optimal objective score, but has an acceptable objective score while satisfying one or more other ride selection criteria, such as may relate to operational efficiency or minimum rider experience, among others. In one embodiment, an objective function accepts as inputs the rider's convenience, the ability to deliver confirmed trips, the fleet operational efficiency, and the current demand. In some embodiments, there will be weightings of each of these terms that may be learned over time, such as through machine learning. The factors or data making up each of these terms or value can also change or be updated over time.

Component metrics, such as the rider's convenience, QoS compliance, and service delivery efficiency can serve at least two purposes. For example, the metrics can help to determine key performance indicator (KPI) values useful for, in some embodiments, planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for the routing system, which can be used to propose or select routes for the various requests. The optimization may require the metrics in some embodiments to be calculated for partial data sets for currently active service windows, which may correspond to a fixed or variable period of time in various embodiments.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, in some embodiments an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. In some embodiments a rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) required of the user for a given route. This can include, as mentioned, the distance between the requested origin and the proposed origin, as well as the distance between the requested destination and the proposed destination. Any walking required to transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location. In some embodiments the score may be determined by an employee of the provider, while in other embodiments a score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages. Similarly, a location with little foot traffic might get a higher score than near a busy intersection or street car tracks. In some embodiments a safety metric may be considered, as may be determined based upon data such as crime statistics, visibility, lighting, and customer reviews, among other such options. Various other factors may be considered as well, as may relate to proximity of train lines, retail shops, coffee shops, and the like. In at least some embodiments, a weighted function of these and other factors can be used to determine a rider's convenience score for a proposed route option.

Another component metric that can be utilized in various embodiments relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancelation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. In some embodiments the historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency in some embodiments can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, in at least some embodiments the efficiency metrics can include factors such as the time needed to prepare for a ride, including getting the vehicle ready (cleaning, placing water bottles or magazines, filling with gas, etc.) as well as driving to the origination location and waiting for the passengers to board. Similarly, the metric can take into account the time needed to finish the ride, such as to drive to a parking location and park the vehicle, clean and check the vehicle, etc. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches in accordance with various embodiments can utilize a metric invariant of the behavior of the routing system. In some embodiments, the ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the routing system to focus on a part of the service window that can still be impacted, typically going forward in time. For prorated and planned but not yet driven routes, the optimal distance may be difficult to assess directly since the route is not actually being driven. To approximate the optimal distance not yet driven, the routing system can prorate the total optimal distance in some embodiments to represent a portion of the planned distance not yet driven.

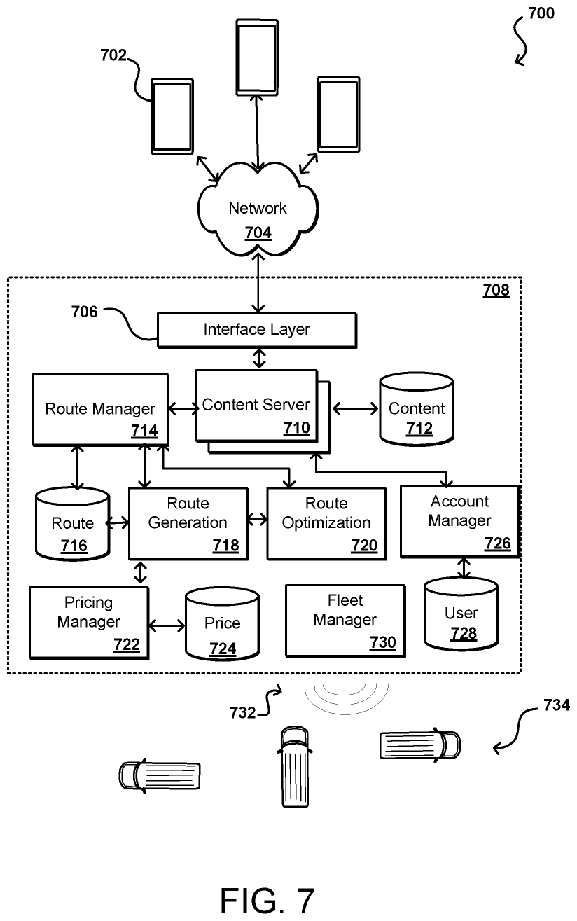

As mentioned, a route optimization system in some embodiments can attempt to utilize such an objective function in order to determine and compare various routing options. FIG. 7 illustrates an example system 700 that can be utilized to determine and manage vehicle routing in accordance with various embodiments. In this system, various users can use applications executing on various types of computing devices 702 to submit route requests over at least one network 704 to be received by an interface layer 706 of a service provider environment 708. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a Wi-Fi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 712 or other such location.

Information for the request can be directed to a route manager 714, such as may include code executing on one or more computing resources, configured to manage aspects of routes to be provided using various vehicles of a vehicle pool or fleet associated with the transport service. The route manager can analyze information for the request, determine available planned routes from a route data store 716 that have capacity can match the criteria of the request, and can provide one or more options back to the corresponding device 702 for selection by the potential rider. The appropriate routes to suggest can be based upon various factors, such as proximity to the origination and destination locations of the request, availability within a determined time window, and the like. In some embodiments, an application on a client device 702 may instead present the available options from which a user can select, and the request can instead involve obtaining a seat for a specific planned route at a particular planned time. As mentioned, in some embodiments the bookings or selections can be made by the route manager automatically based on various criteria, among other such options.

As mentioned, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 714 can receive several such requests, and can attempt to determine the best selection of routes to satisfy the various requests. In this example the route manager can work with a route generation module 718 that can take the inputs from the various requests and provide a set of route options that can satisfy those requests. This can include options with different numbers of vehicles, different vehicle selections or placements, different modes of transportation, different segment options, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 722 can determine the cost for a specific request using pricing data and guidelines from a price repository 724, which the user can then accept or reject.

In this example, the route generation module 718 can generate a set of routing options based on the received requests for a specified area over a specified period of time. A route optimization module 720 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 720 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

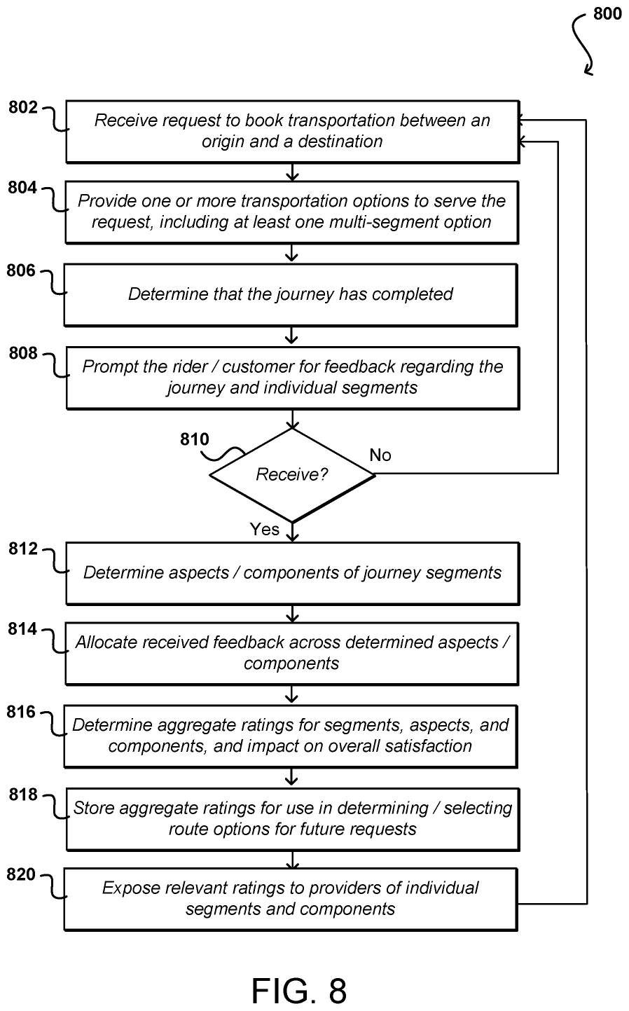

FIG. 8 illustrates an example process 800 for obtaining performance data for various transportation options that can be utilized in accordance with various embodiments. It should be understood that, for this and other processes discussed herein, there can be additional, fewer, or alternative steps, performed in similar or alternative steps, or in parallel, within the scope of the various embodiments unless otherwise stated. In this example, a request is received 802 for a journey between an origin and a destination, or other such criteria. The journey can involve at least two segments, or will potentially involve more than one segment for at least some options. The request can be received to a system for an appropriate entity, such as a transportation service provider. As discussed herein, the transport for one or more segments of a journey may be provided by an entity other than the transportation service provider, and can include public entities or other third party entities that may have a contractual relationship with the service provider. A number of such requests can be received from, or on behalf of, various potential customers of the transportation service provider. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well.

In order to determine how to best serve the received request, this example process first determines a set of options satisfying the criteria for the journey. The criteria can include, for example, at least an approximate journey start time and location, as well as a target destination location. Other criteria can be provided or utilized as well, including many of those discussed and suggested elsewhere herein. The process can involve determining available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options. Based at least in part upon the various available vehicles and capacity, a set of potential routing options can be determined. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis. Further, for multi-segment routing options, the route determination algorithm can take into account possible connection points, as well as the possible routing options from those connection points to the target destination, including the appropriate time windows for each.

The determined routing options can be processed and/or optimized to attempt to determine or identify an optimal routing option, or a set of highest ranked routing options, among other such approaches. Information for one or more of these transportation options for the journey can then be provided 804 for communication to the customer or intended rider, such as by sending the information for display through a transportation application executing on a smartphone of the customer or rider. The information in some embodiments can provide one or more options for the user to select or confirm, in order to confirm a reservation or booking of a seat or other amount of capacity on the selected option for any or all segments of the journey. In this example, the option can include a route with at least two different segments, which can be provided by the same or a different mode of transportation provided by the same or a different provider, as discussed herein.

Information for the journey can be stored or cached, and the progress monitored in at least some embodiments. Subsequently, it can be determined 806 that the journey has completed, with the rider either completing all segments or terminating before the target destination, among other such options. Upon completion (or near completion in some embodiments) an application or other interface or notification can prompt 808 the rider or customer to provide feedback regarding the journey, including the individual segments. Various other aspects may be available for feedback as well within the scope of the various embodiments. The feedback can include ratings, scores, text, or other types of feedback discussed or suggested herein. A determination can be made 810 as to whether any feedback data was received. If not, the process can continue for the next request.

If, however, at least some feedback or rating data is received, relevant aspects and/or components of the completed journey can be determined 812, as may relate to routes, vehicles, drivers, connections, or other aspects of the individual segments or overall journey. The received feedback can be allocated 814, as appropriate and available, across the determined aspects, components, segments, and/or journey. For example, the rating for a particular segment might be allocated to the vehicle, driver, and route for that segment. Aggregate ratings for the segments, aspects, components, and/or route can then be determined 816 using the received feedback and other feedback data received from other users or previous journeys for the same user. The impact of those individual aspects or components, etc., can also be determined with respect to the overall journey or route. The data can also be processed or normalized, such as to remove outliers or reduce noise in the data, decay the data such that more recent feedback counts more towards the aggregate rating, etc. The aggregate rating data can then be stored 818 for use in determining and/or selecting route options for future requests. In this example, the relevant rating data can also be exposed 820 or otherwise made accessible to the providers or entities associated with individual segments or components, such as the providers of the vehicles that performed the various segment routes or operate the connection locations, etc. The process can continue as additional transportation or mobility requests are received and performed.

Such an approach has advantages not only in the ability to provide performance data for providers, but also in the reduction of resources needed to provide such a service. The ability to provide more accurate suggestions and selections for users will decrease the number of changes users make, as well as the number of options to be provided and reviewed by the users. This will reduce the amount of data transferred and stored, as well as the length of sessions for reserving transportation. Such approaches can also increase return ridership, which reduces the computing capacity needed to set up new accounts and riders for the various segment options. Knowing user preference data and segment options also allows for default recommendations to be retained for various users, which further reduces processing time. Various other computer system operations are obtained as well as would be apparent to one of ordinary skill in the art in light of the teachings and suggestions contained herein.

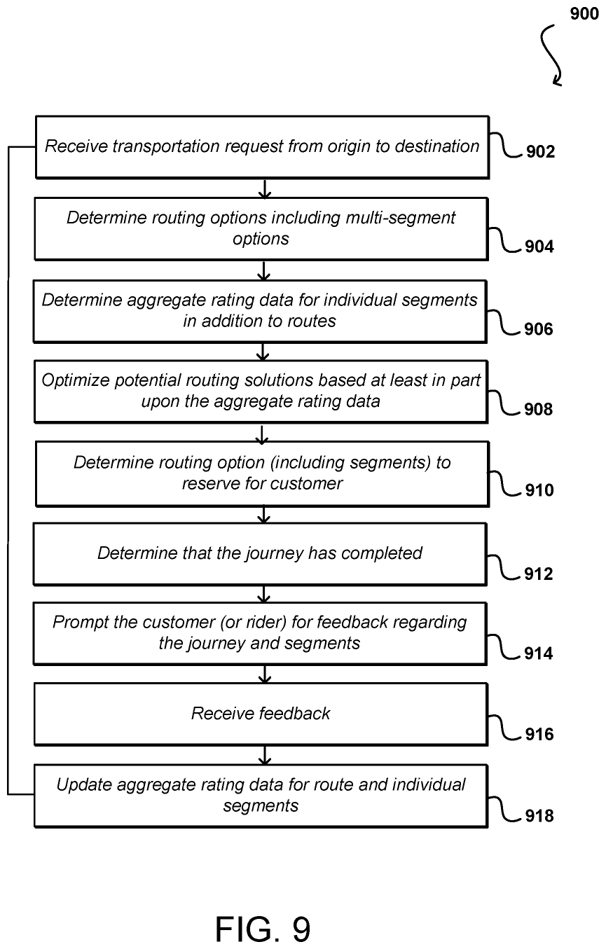

FIG. 9 illustrates an example process 900 for using segment-specific feedback to determine routing options that can be utilized in accordance with various embodiments. In this example, a transportation request is received 902 to transport one or more riders between an origin and a destination, in many instances including at least some time component or other information. One or more routing options can then be determined 904 as discussed herein, which can include one or more multi-segment options for completing the requested journey. Based at least in part upon the determined options, aggregate rating or performance data can be determined 906 for the individual segments for those options, in addition to the overall route or journey ratings. The potential routing solutions can then be optimized 908 based at least in part upon the aggregated ratings, as well as any customer preference or other data as discussed and suggested herein. This can include, for example, minimum ratings thresholds or other such criteria. A specific routing option for the journey can be determined 910, automatically or in response to customer selection, for example, which can include the segments to be reserved for the customer for the journey. In this example, the capacity (i.e., a seat on each vehicle) is reserved for the segments of the journey, and a determination can be made as to the customer or rider utilizing the capacity for the journey.

Subsequently, it can be determined 912 that the journey has completed. A mobile application, notification, or other such interface can be used to prompt 914 the user for feedback regarding the journey, including the individual segments and other such aspects or components. At least some of the feedback can then be received 916 from the customer or rider, and this information used to update 918 the aggregate rating or performance data for the individual segments, as well as the overall route or journey. As mentioned, the ratings can be allocated across various components or aspects of the journey as well for use in determining and/or optimizing routing options for subsequent transportation or mobility requests.

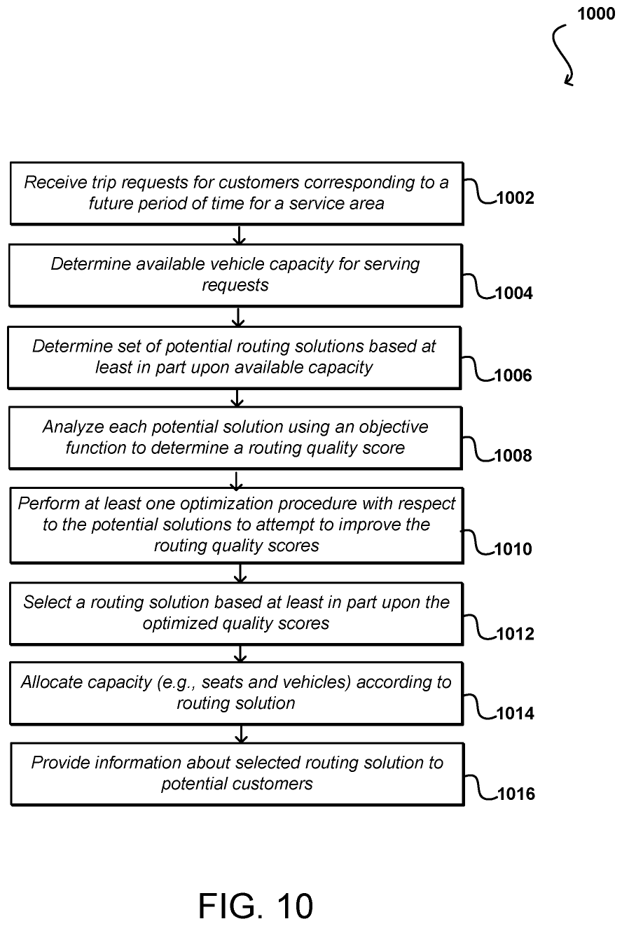

For various journeys, requests can be received for a number of potential riders and the best set of options can be determined that satisfies the customer requests but also satisfies various business requirements as discussed herein. FIG. 10 illustrates an example process 1000 that can be used to determine various routing options to serve a set of rider requests in accordance with various embodiments. As mentioned, various other route determination and optimization approaches can be used as well within the scope of the various embodiments. In this example, a number or journey or trip requests are received 1002 from, or on behalf of, various potential customers of a transportation service. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well. In order to determine how to best serve the requests, this example process first determines 1004 available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options.

Based at least in part upon the various available vehicles and capacity, a set of potential routing solutions can be determined 1006. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis.

In this example process, the various potential routing solutions can be analyzed 1008 using an objective function that balances various factors, such as provider efficiency and customer satisfaction, or at least takes those factors into consideration as discussed elsewhere herein. Each potential routing solution that is analyzed using the function, or at least that meets specific minimum criteria, can be provided with a routing quality score generated inserting the relevant values for the solution into the objective function. This can include, for example determining a weighted combination of various quality factors as discussed herein. In some embodiments, the solution with the best (e.g., highest or lowest) quality score can be selected for implementation. In this example, however, at least one optimization procedure is performed 1010 with respect to at least some of the potential solutions. In some embodiments the process might be performed for all potential solutions, while in others only a subset of the solutions will go through an optimization procedure, where solutions with a quality score outside an acceptable range may not be considered for optimization in order to conserve time and resources. The optimization process can attempt to improve the quality scores of the various solutions. As discussed herein, an optimization process can attempt to adjust various parameters of the solution, such as to adjust pickup times, stops per route, capacity distribution, and the like. As mentioned, multiple optimization procedures may be applied in some embodiments, where the algorithms may look at different factors or adjustable ranges, etc. Different optimization algorithms may also optimize for, or prioritize, different factors, such as different QoS or efficiency components, profitability, rider comfort, and the like.

After the optimization, at least some of the various proposed solutions may have updated quality scores. Some of the proposed solutions may also have been removed from consideration based on, for example, unacceptable quality scores or an inability to adequately serve a sufficient number of the pending requests, among other such factors. A specific routing solution can then be selected 1012 from the remaining solutions, where the solution can be selected based at least in part upon the optimized quality scores. For example, if optimizing for factors such as profitability or customer satisfaction rating, it can be desirable to select the option with the highest score. If optimizing for factors such as cost, it might be desirable to select the option with the lowest score. Other options can be utilized as well, such as to select the score closest to a target number (e.g., zero). As mentioned, other factors may be considered as well. For example, a solution might be selected that has close to the best quality score, but has a much better profitability or customer satisfaction value, or satisfies one or more other such goals or criteria. Once the solution is determined, the appropriate capacity can be allocated 1014 based upon vehicles and seating, among other potential options, determined to be available for the determined region at, or near, the future period of time. This can include, for example, determining routes and stops, and assigning vehicles with appropriate capacity to specific routes. The assignment of specific types of vehicles for certain routes may also be specified in the routing options, as there may be certain types of vehicles that get better gas mileage in town and some that get better gas mileage on the highway, for example, such that operational costs can be broken down by types of vehicles as well. In some embodiments specific vehicles might also be due to service for a specific mileage target, which can be factored in as well as other factors, such as cost per mile, type of gasoline, fuel, or power utilized, and the like. Information about the selected routing option can then be provided 1016 to particular customers, such as those associated with the received requests. The information can indicate to the users various aspects such as the time and location of pickup, the route being taken, the location and approximate time of arrival at the destination, and potentially information about the specific vehicle and driver, among other such options.

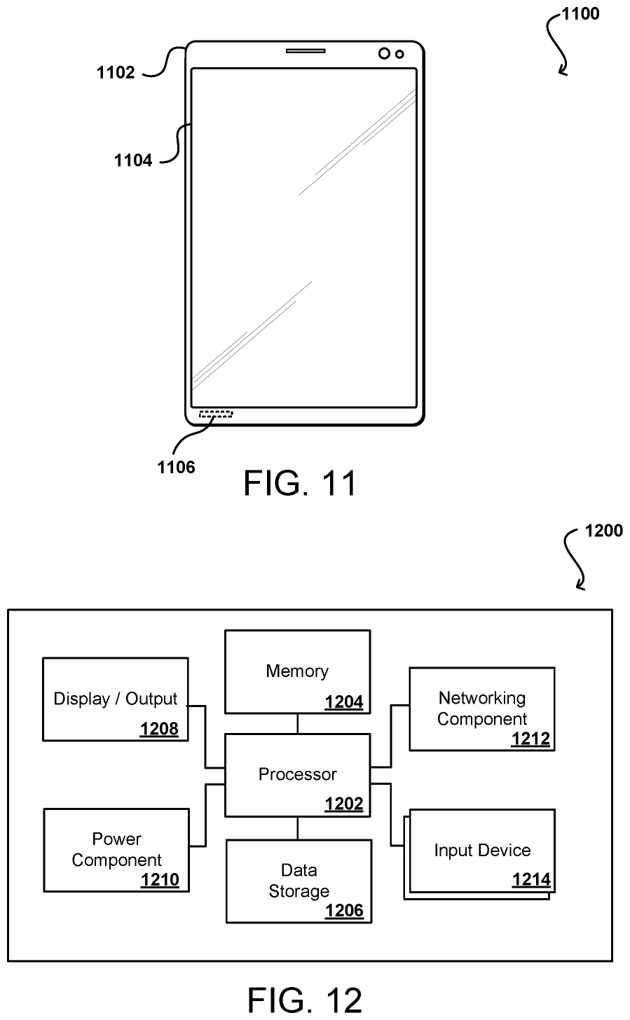

FIG. 11 illustrates an example computing device 1100 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 1100 has an outer casing 1102 covering the various internal components, and a display screen 1104 such as a touch screen capable of receiving user input during operation of the device. These can be additional display or output components as well, and not all computing devices will include display screens as known in the art. The device can include one or more networking or communication components 1106, such as may include at least one communications subsystem for supporting technologies such as cellular communications, Wi-Fi communications, BLUETOOTH® communications, and so on. There may also be wired ports or connections for connecting via a land line or other physical networking or communications component.

FIG. 12 illustrates an example set of components 1200 that can comprise a computing device 800 such as the device described with respect to FIG. 11, as well as computing devices for other purposes such as application servers and data servers. The illustrated example device includes at least one main processor 1202 for executing instructions stored in physical memory 1204 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 1206 for the device. Application instructions for execution by the at least one processor 1202 can be stored by the data storage 1206 then loaded into memory 1204 as needed for operation of the device 1200. The processor can also have internal memory in some embodiments for temporarily storing data and instructions for processing. The device can also support removable memory useful for sharing information with other devices. The device will also include one or more power components 1210 for powering the device. The power components can include, for example, a battery compartment for powering the device using a rechargeable battery, an internal power supply, or a port for receiving external power, among other such options.

The computing device may include, or be in communication with, at least one type of display element 1208, such as a touch screen, organic light emitting diode (OLED), or liquid crystal display (LCD). Some devices may include multiple display elements, as may also include LEDs, projectors, and the like. The device can include at least one communication or networking component 1212, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 1214 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk

(DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method, comprising:
receiving a transportation request for a customer, the transportation request specifying at least an origin, a destination, and a time component;
reserving, on behalf of the customer, capacity on a respective vehicle for each segment of a multi-segment journey for serving the transportation request;
determining that the customer has completed the multi-segment journey;
prompting the customer to provide feedback with respect to each segment and the multi-segment journey;
aggregating the feedback, received on behalf of the customer, with other feedback data received from other customers to generate performance data for the segments and the multi-segment journey; and
utilizing the performance data to determine transportation options for serving future transportation requests.

2. The computer-implemented method of claim 1, further comprising:
determining, using a routing determination algorithm and a current version of the performance data, a set of potential routing solutions to serve the transportation request, the routing solutions relating to multi-segment journeys between the origin and the destination;
providing information for a subset of the potential routing solutions for display to the customer, the information including at least time and location information for each of the multi-segment journeys of the subset; and
receiving, on behalf of the customer, a selection of the multi-segment journey from the subset.

3. The computer-implemented method of claim 1, wherein the feedback includes at least a rating for each segment and the multi-segment journey, and wherein at least two transportation providers operate the respective vehicles for the segments of the multi-segment journey.

4. The computer-implemented method of claim 3, further comprising:
providing, to the at least two transportation providers, at least a respective portion of the feedback information for the segments operated by the transportation providers.

5. The computer-implemented method of claim 1, further comprising:
obtaining, from the customer, preference data with respect to transportation options; and
utilizing the preference data with the performance data to optimize transportation options provided for serving future transportation requests for the customer.

6. The computer-implemented method of claim 1, wherein at least one segment of the multi-segment journey is provided by a public entity unrelated to a transportation service reserving the capacity for the customer.

7. The computer-implemented method of claim 1, further comprising:
determining transportation aspects related to the segments of the multi-segment journey, the transportation aspects including at least one of a driver identity, a route identity, a vehicle identity, a connection location, or a time component; and
allocating the feedback for a specified segment across the transportation aspects associated with the specified segment.

8. A computer-implemented method, comprising:
determining that a passenger has completed a multi-segment journey, segments of the multi-segment journey operated using different transportation options;
receiving, on behalf of the passenger, feedback information relating to the segments and the multi-segment journey;
aggregating the feedback, received on behalf of the passenger, with other feedback data received from other passengers to generate performance data for the segments and the multi-segment journey; and
utilizing the performance data to determine transportation options for serving future transportation requests.

9. The computer-implemented method of claim 8, further comprising:
receiving a transportation request for the passenger, the transportation request specifying at least an origin and a destination; and
reserving, on behalf of the passenger, capacity on a respective vehicle for each segment of the multi-segment journey for serving the transportation request.

10. The computer-implemented method of claim 8, further comprising:
determining that the passenger has completed the multi-segment journey; and
prompting the passenger to provide the feedback with respect to each segment and the multi-segment journey.

11. The computer-implemented method of claim 8, wherein the different transportation options are provided by separate transportation entities.

12. The computer-implemented method of claim 11, wherein the receiving and the aggregating of the feedback are performed by a transportation management service separate from the transportation entities.

13. The computer-implemented method of claim 8, wherein the different transportation options include at least one of a shuttle, a bus, a train, a van, a car, a bike, or a scooter.

14. The computer-implemented method of claim 8, wherein a first segment of the multi-segment journey involves a fixed-route mode of transportation, while a second segment involves a flexible-route mode of transportation.

15. The computer-implemented method of claim 8, further comprising:
determining, using a routing determination algorithm and a current version of the performance data, a set of potential routing solutions to serve a transportation request for the multi-segment journey;
providing information for a subset of the potential routing solutions for display to the passenger, the information including at least time and location information for each of the multi-segment journeys of the subset; and
receiving, on behalf of the passenger, a selection of the multi-segment journey from the subset.

16. The computer-implemented method of claim 8, further comprising:
obtaining, from the passenger, preference data with respect to transportation options; and
utilizing the preference data with the performance data to optimize transportation options provided for serving future transportation requests for the passenger.

17. A system, comprising:
at least one processor; and
memory including instructions that, when executed by the at least one processor, cause the system to:
determine that a passenger has completed a multi-segment journey, the segments of the multi-segment journey operated using different transportation options;
receive, on behalf of the passenger, feedback information relating to the segments and the multi-segment journey;
aggregate the feedback, received on behalf of the passenger, with other feedback data received from other passengers to generate performance data for the segments and the multi-segment journey; and
utilize the performance data to determine transportation options for serving future transportation requests.

18. The system of claim 17, wherein the instructions when executed further cause the system to:
specify at least an origin, a destination, and a time component;
reserve, on behalf of the passenger, capacity on a respective vehicle for each segment of the multi-segment journey for serving the transportation request;
determine that the passenger has completed the multi-segment journey; and
prompt the passenger to provide the feedback with respect to each segment and the multi-segment journey.

19. The system of claim 17, wherein the different transportation options are provided by separate transportation entities, and wherein the receiving and the aggregating of the feedback are performed by a transportation management service separate from the transportation entities.

20. The system of claim 17, wherein a first segment of the multi-segment journey involves a fixed-route mode of transportation, while a second segment involves a flexible-route mode of transportation.
